(19) United States
(12) Patent Application Publication
(10) Pub. No.: US 2018/0125277 A1
(43) Pub. Date: May 10, 2018

(54) MAT

(71) Applicant: Trademark Global, LLC, Lorain, OH (US)

(72) Inventors: Daniel A. Sustar, Lorain, OH (US); Said Samman, Lorain, OH (US)

(73) Assignee: Trademark Global, LLC, Lorain, OH (US)

(21) Appl. No.: 15/804,837

(22) Filed: Nov. 6, 2017

Related U.S. Application Data
(60) Provisional application No. 62/418,054, filed on Nov. 4, 2016.

(51) Int. Cl. A47G 27/02; B32B 5/02; B32B 5/18; B32B 5/24; B32B 5/32; B32B 25/08; B32B 27/06; B32B 27/40; B32B 27/12; B32B 27/34

(52) U.S. Cl. CPC A47G 27/0225; B32B 2471/04; B32B 5/18; B32B 5/245; B32B 5/32; B32B 25/08; B32B 27/065; B32B 27/40; B32B 27/12; B32B 27/34; B32B 2266/0278; B32B 2262/0261; B32B 2307/724; B32B 2307/744; B32B 5/024

(57) ABSTRACT

A mat for use in potentially wet areas is provided and includes a top fiber layer, a compressible intermediate layer, and a bottom layer having a breathable fiber portion and a non-skid portion.

### CROSS-REFERENCE TO RELATED APPLICATIONS

This application claims the benefit of U.S. Provisional Patent Application Ser. No. 62/418,054 entitled “Mat” filed on Nov. 4, 2016, the entirety of which is incorporated by reference herein.

### ORIGIN

The present invention relates generally to household mats, and in particular, bath mats. More particularly, the present invention is directed to household mats, including bath mats, having non-skid- and fast-drying-qualities and components.

### BACKGROUND

Household mats for use in a bathroom or kitchen are configured to absorb water and/or provide comfort to the user. The mat may include foam (e.g., memory foam) to provide comfort and may also include a slip resistant backing to guard against accidental slippage of the mat and ultimately to prevent the user from slipping. Memory foam mats, however, are either available in a fast drying option or a non-skid option, but not both. For example, floor mats consisting of rubber backed carpet tuft are made with either a smooth back, primarily for solid or non-carpeted floors, or with a variety of grippers (e.g., suction cups) arranged to reduce the movement on carpeted floors. These approaches, however, resulted in floor mats that were not skid resistant on all types of floors. Movement of the mat is created by the force of foot traffic on the mat which causes a deformation around the compressed area and then upon removal of such force the mat returns to a different position.

Another disadvantage of the above mats is that they tend to be rather expensive due to the relatively high cost of the rubber backing material. As a result, these mats have limited commercial success in certain market sectors, where a lower cost product is required. For example, in the commercial and retail or residential market sectors, rubber backed dust control mats have a very low percentage market penetration. The remainder of mats sold into this market sector being either unbacked or backed with PVC or latex.

PVC and latex backed mats, however, have a number of disadvantages as compared to the conventional rubber backed mats. Specifically, PVC backed mats have poor flexibility, and after being unrolled, such mats often do not lie flat on the floor. PVC backed mats also have an inferior appearance and feel when compared with rubber backed mats, can become brittle with age, and can have poor resistance to movement when placed on top of carpet. There are also growing environmental concerns associated with the manufacture and disposal of PVC backed mats.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In an aspect of the innovation, the innovative mat overcomes the aforementioned disadvantages by merging two materials to a cushioned layer in a manner to expose enough of the fast drying material to retain the fast drying properties and also to retain anti-skid properties. The two materials merged together on the bottom of the mat both are adhered to the foam section of the mat and then sewn in place. The dissimilar materials are pre-joined prior to being applied to the foam base of the mat. The pre-joining is done by adhesive or sewing, depending on the geometric design configuration of the mat.

In another aspect of the innovation, the innovative mat uses a design of non-skid material attached to a bottom of the mat in a fashion that allows a fast drying area of the mat to still be exposed, thus allowing the mat to exhibit a fast drying property.

In still another aspect of the innovation, a mat for use in potentially wet areas is provided that includes a first layer including a fiber material, a compressible second layer disposed below the first layer, and a third layer disposed below the compressible second layer and including a breathable fiber portion and a non-skid material.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

The present invention may take physical form in certain parts and arrangement of parts, the preferred embodiment of which will be described in detail in the specification and illustrated in the accompanying drawings which form a part hereof, and wherein:

FIG. 1 is a top perspective view of one example embodiment of an innovative mat in accordance with an aspect of the innovation.

FIG. 2 is a bottom perspective view of the innovative mat in accordance with an aspect of the innovation.

FIG. 3 is a top view of the innovative mat in accordance with an aspect of the innovation.

FIG. 4 is a side view of the innovative mat in accordance with an aspect of the innovation.

FIG. 5 is a bottom view of the innovative mat in accordance with an aspect of the innovation.

FIGS. 6-8 are bottom views of other example embodiments of an innovative mat in accordance with an aspect of the innovation.

FIG. 9 is a top perspective view of one example embodiment of an innovative mat in accordance with an aspect of the innovation.

FIG. 10 is a bottom perspective view of the innovative mat in accordance with an aspect of the innovation.

FIG. 11 is a top view of the innovative mat in accordance with an aspect of the innovation.

FIGS. 12 and 13 are side views of the innovative mat in accordance with an aspect of the innovation.

FIGS. 14-16 are bottom views of other example embodiments of an innovative mat in accordance with an aspect of the innovation.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness, orientation, configuration, etc.), it is to be understood that the features, functions and benefits of the innovation can employ characteristics that vary from those described herein. These alternatives are to be included within the scope of the innovation and claims appended hereto.

The innovation disclosed herein overcomes the aforementioned disadvantages by providing an improved slip resistant, cushioned, fast drying mat for use in potentially wet areas in accordance with an aspect of the innovation. The innovative mat improves the use of memory foam and uses a non-skid material that attaches to a bottom of the mat in a fashion to allow a fast drying (breathable) area to remain exposed. This allows the mat to contemporaneously exhibit a fast drying property and anti-slip properties. Another advantage of the innovative mat is that the configuration of the non-skid material and breathable material facilitates a washability of the mat.

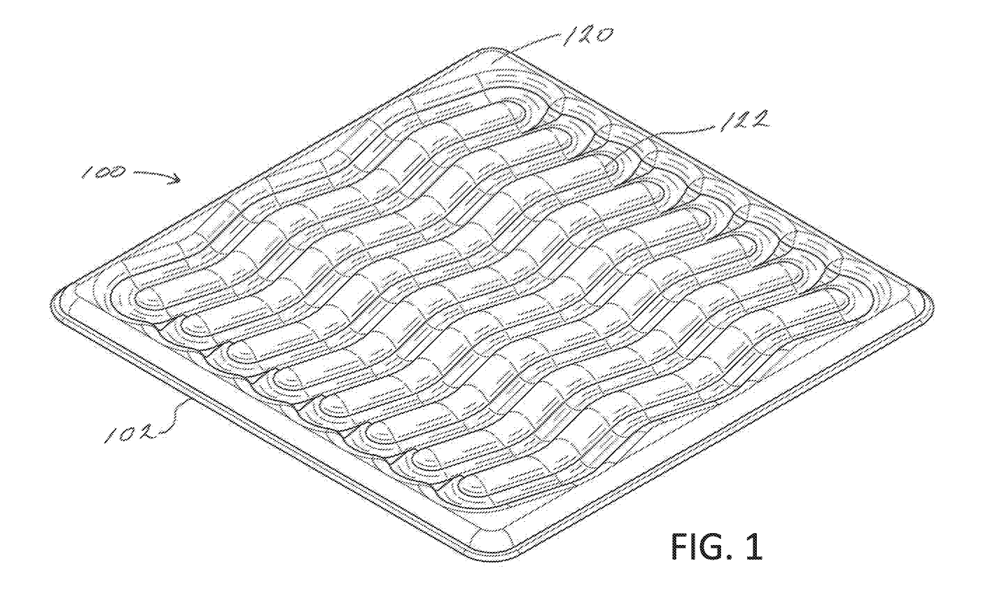

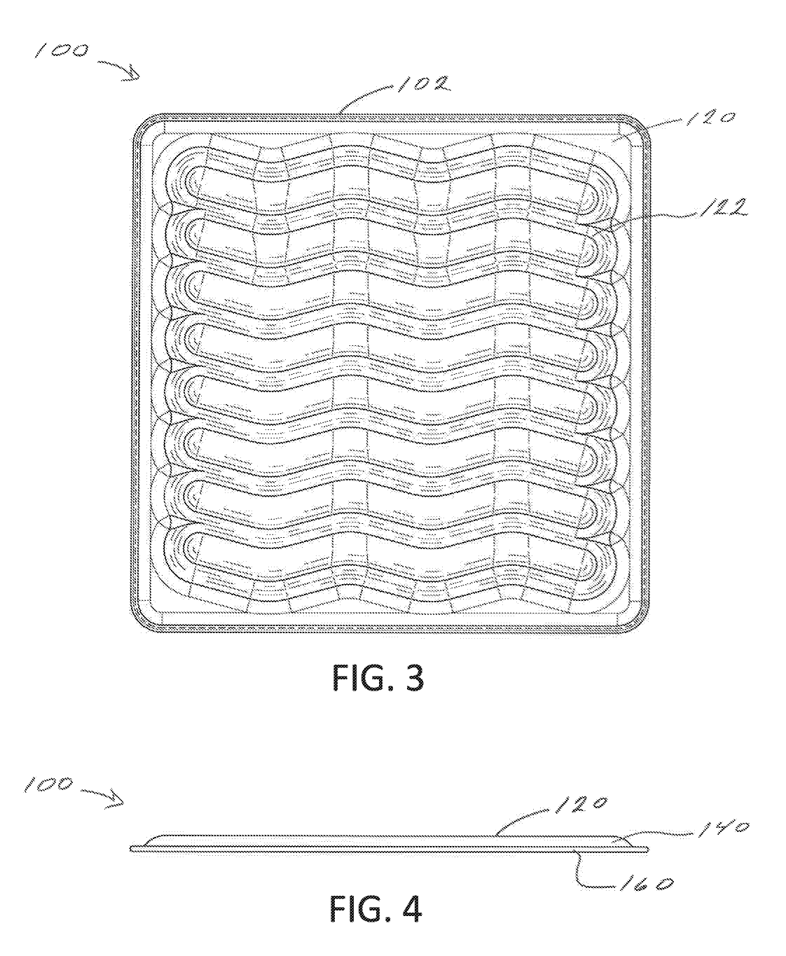

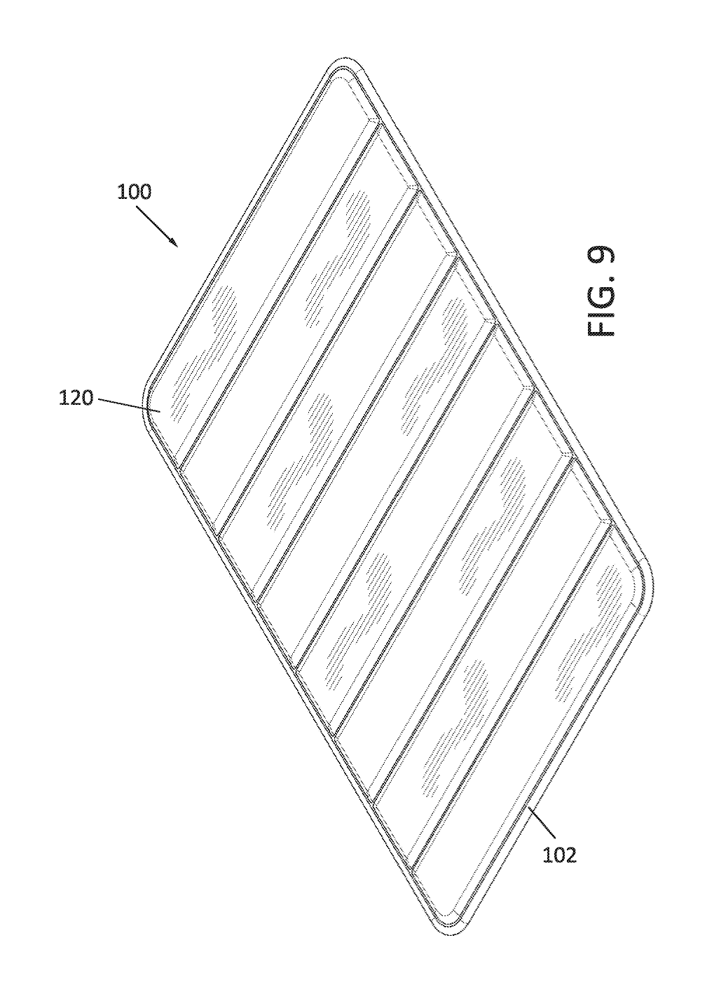

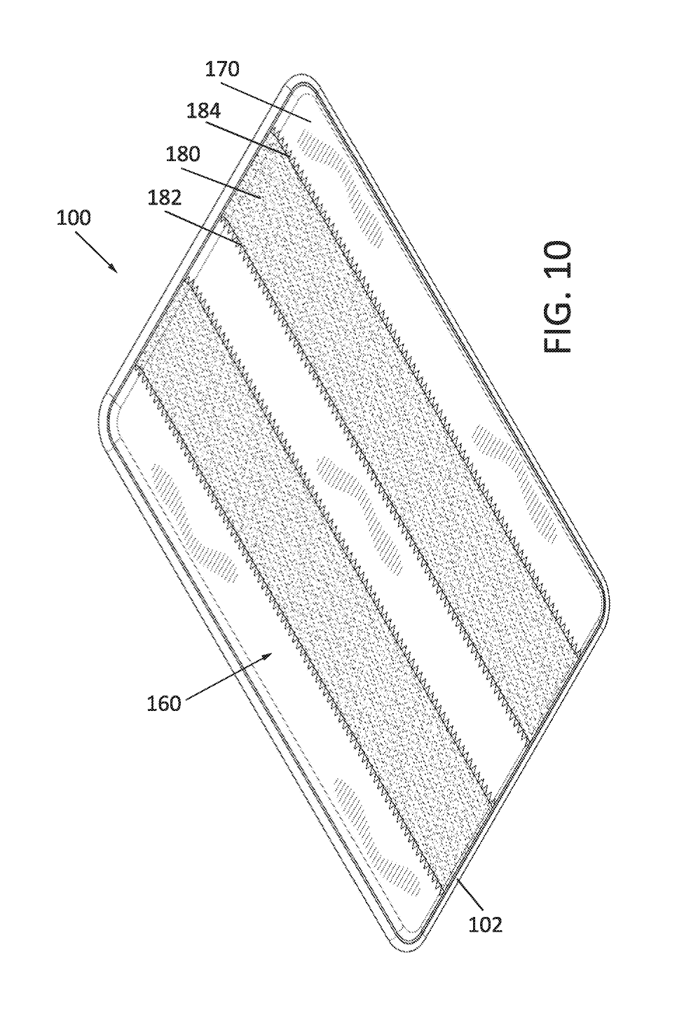

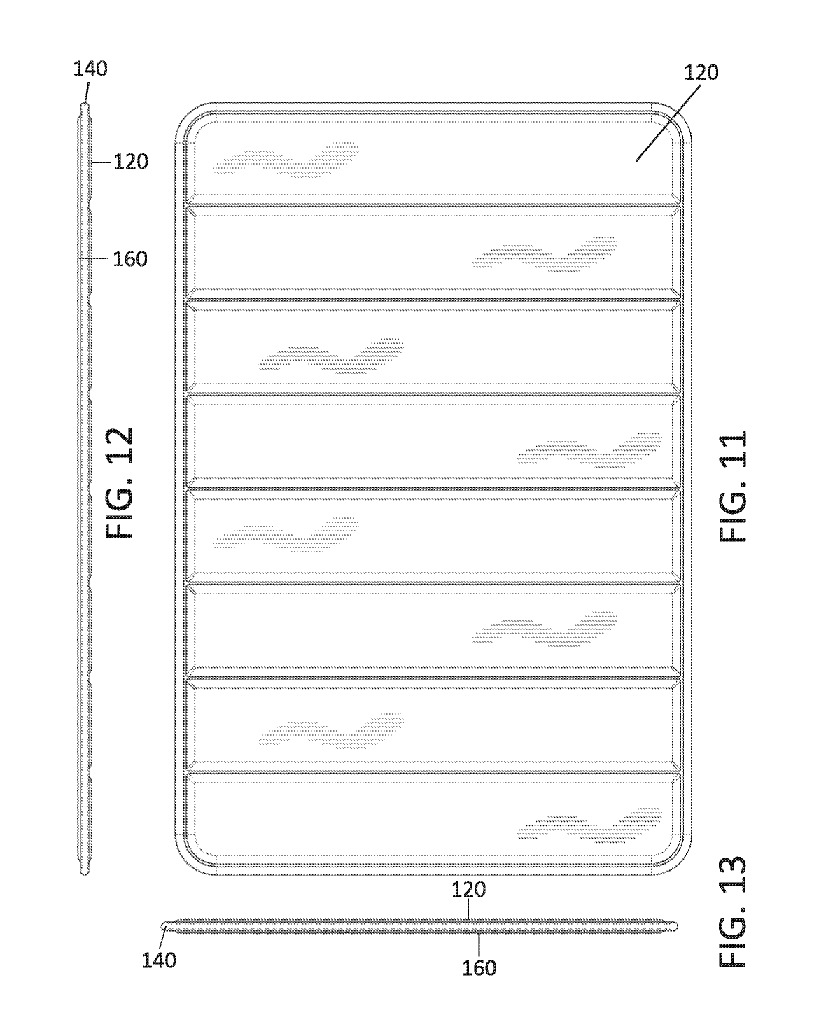

Referring now to the drawings, FIGS. 1-5 illustrate one example embodiment of an innovative cushioned, non-skid, quick drying mat (hereinafter “mat”) 100 for household use in areas where water can potentially spill onto a floor, such as but not limited to, a bathroom, kitchen, utility room, etc. in accordance with an aspect of the innovation. The mat 100 includes a bonded edged perimeter 102 and multiple layers including a top (first) layer 120, one or more intermediate (second) layers 140, and a bottom (third) layer 160. FIGS. 9-13 illustrate another example embodiment of an innovative mat 100.

The top layer 120 is continuous and includes a breathable, cloth/fabric like material having a top surface 122 that is directly exposed to moisture and every day foot traffic wear and tear. In embodiments of the innovation, the top layer 120 may be formed from a fiber material, a knit polyester material, cotton, chenille, woven materials, etc. In other embodiments, the top layer 120 may be formed from a microfiber composition, such as but not limited to polyesters, polyamides, polypropylene, etc. In addition, the polyamide material may include materials, such as but not limited to, nylon, aramids, para-aramids, and meta-aramids. The top layer 120 may be formed in various weights and pile heights, and may be formed from a high-absorbency material. Additional features that may factor into the selection of the top layer 120 may include durability, strength, softness, anti-bacterial properties, etc. The top layer 120 may also be pretreated to guard against staining, mildew, bacteria, etc. As shown, the top layer 120 exhibits a substantially wavy contoured surface. However, it should be appreciated that the contour and/or appearance of the surface of the top layer 120 serves as aesthetic purposes only and that the contour and/or appearance of the surface of the top layer 120 may be any conventional in the art, such as but not limited to flat, wavy, shaggy, pilly and the like.

The intermediate layer 140 is a breathable material that facilitates quick drying and may be comprised of one or more compressible layers that provide cushion to the mat 100 thereby enhancing comfort for the user. The compressible layers may be formed from elastic or viscoelastic foam materials, such as but not limited to, memory foam. For example, the compressible layers may be formed from polyurethane, such as but not limited to, viscoelastic polyurethane foam (e.g., memory foam) or a low-resilience polyurethane foam. In other embodiments, the intermediate layer 140 may be a composite of multiple foam layers. For example, foams of various densities and/or thicknesses may be secured together to produce various cushioning effects.

The intermediate layer 140 may have a thickness and density that varies based on intended use. For example, areas where the mat 100 may be used to stand on for a longer period of time, such as adjacent to a sink (e.g., bathroom, kitchen, utility room, etc.) may have more cushioning than a mat 100 adjacent to a shower or bathtub.

In one embodiment, an upper surface of the intermediate layer 140 may be attached to a bottom surface of the top layer 120 using an adhesive, such as but not limited to, a polyurethane-based adhesive, a water-based adhesive, etc. In an alternative embodiment, the intermediate layer 130 may be stitched or sewn to the top layer around the edges of the mat 100 as will be described further below.

The bottom layer 160 is configured to contact the floor, carpet, etc. (hereinafter “floor”) and provide resistance against accidental slippage of the mat 100 and also provide quick drying properties. The bottom layer 160 includes a perimeter 162, a breathable fabric portion 170, and a non-skid portion 180. The breathable fabric portion 170 and the non-skid portion 180 are configured to provide anti-skid and quick drying properties when hung to allow to air dry or dried in a conventional machine dryer.

The breathable fabric portion 170 is a cloth/fabric like material that has quick drying properties and includes a perimeter (edge) 172, and a bottom surface 174 that contacts the floor and may be formed from a fiber material, a knit polyester material, cotton, chenille, woven materials, etc. In other embodiments, the breathable fabric portion 170 may be formed from a microfiber composition, such as but not limited to polyesters, polyamides, polypropylene, etc. In addition, the polyamide material may include materials, such as but not limited to, nylon, aramids, para-aramids, and meta-aramids.

The breathable fabric portion 170 may be formed in various weights and pile heights, and may be formed from a high-absorbency material. Additional features that may factor into the selection of the top layer 120 may include durability, strength, softness, anti-bacterial properties, etc. The breathable fabric portion 170 may also be pretreated to guard against staining, mildew, bacteria, etc.

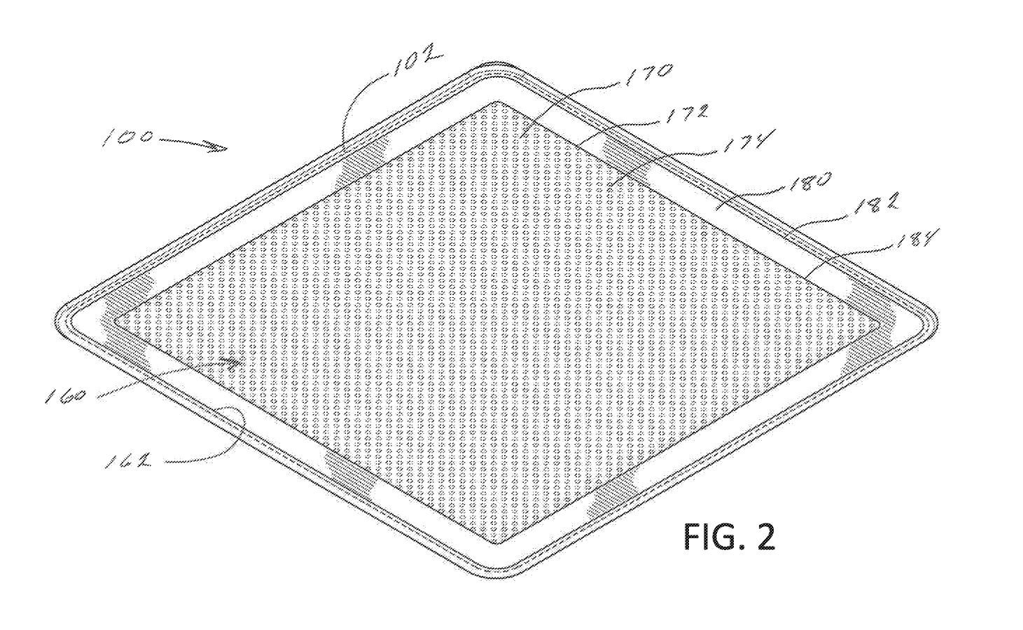

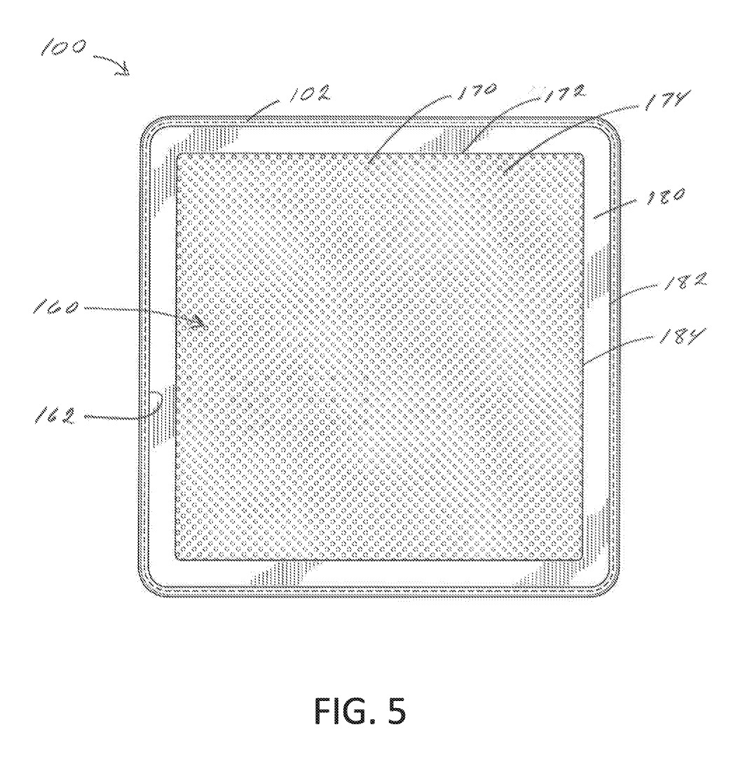

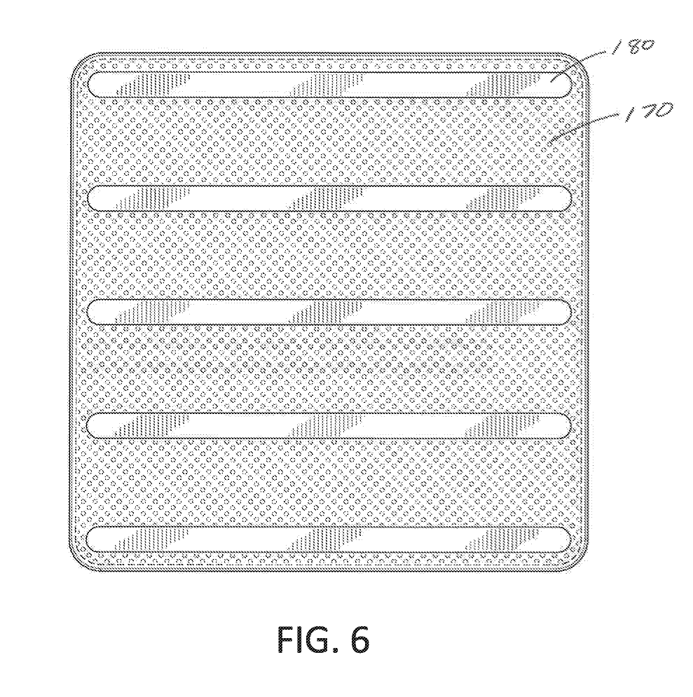

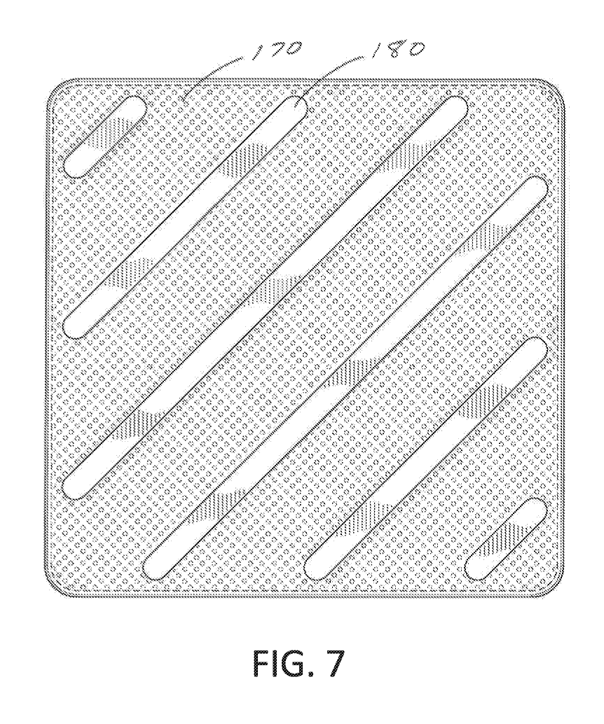

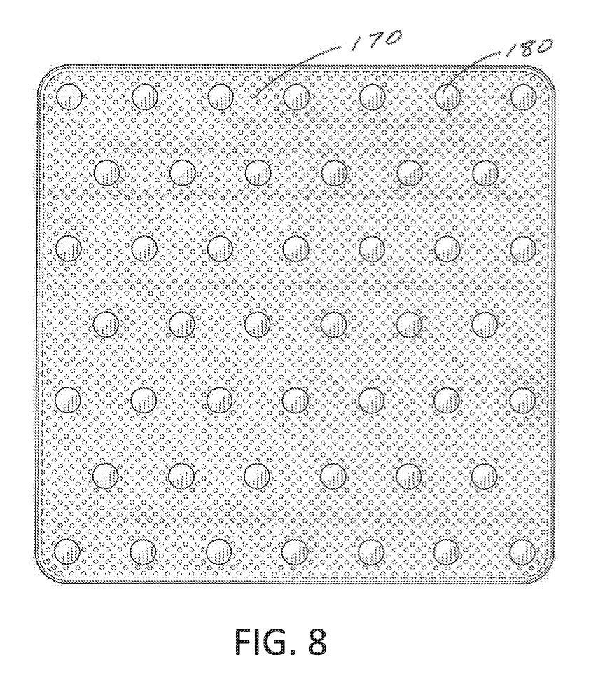

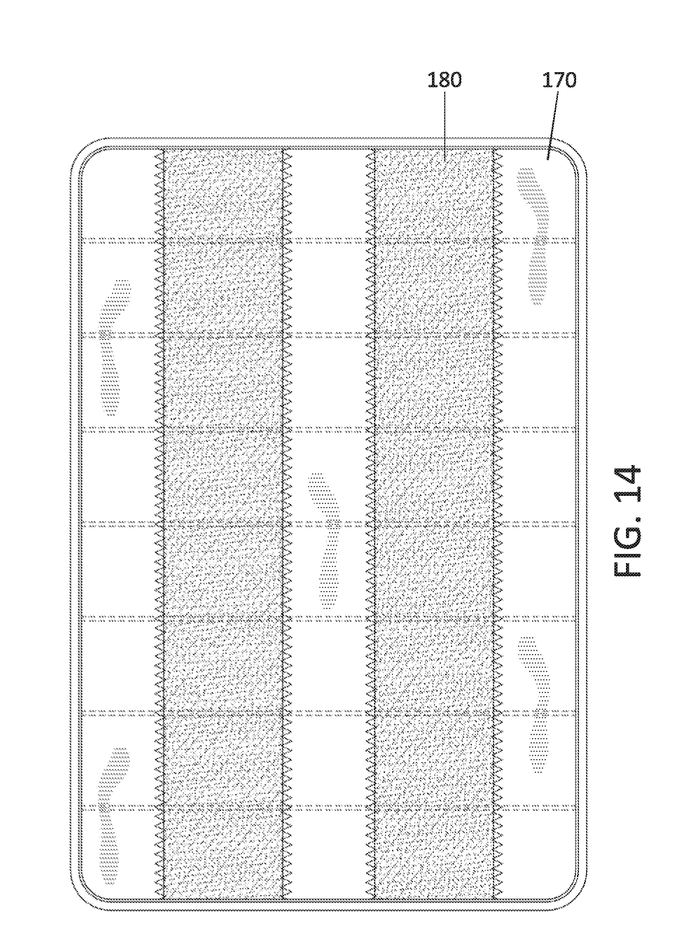

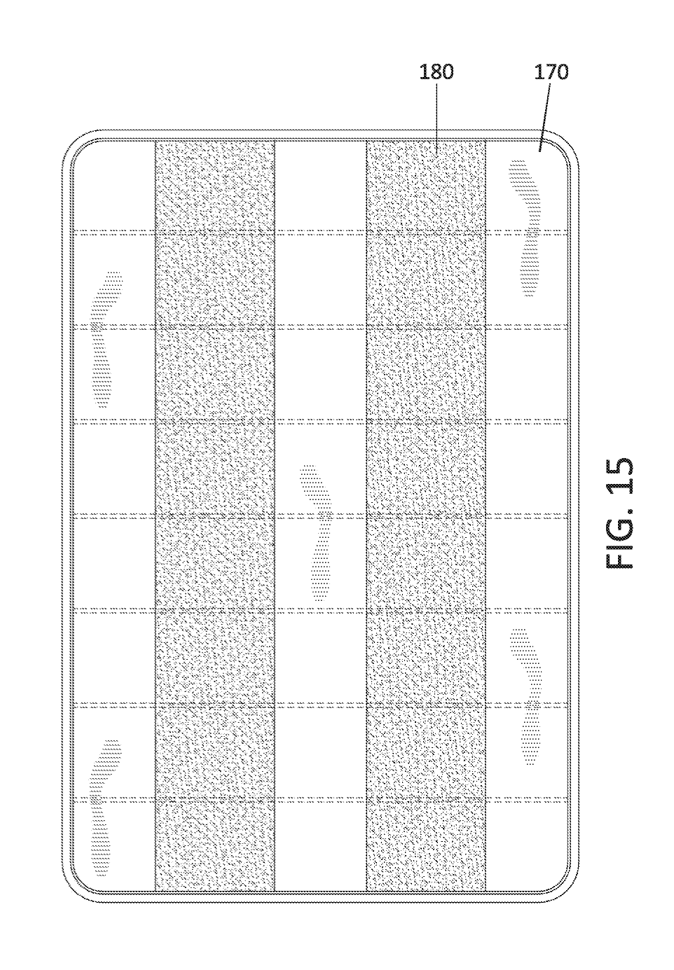

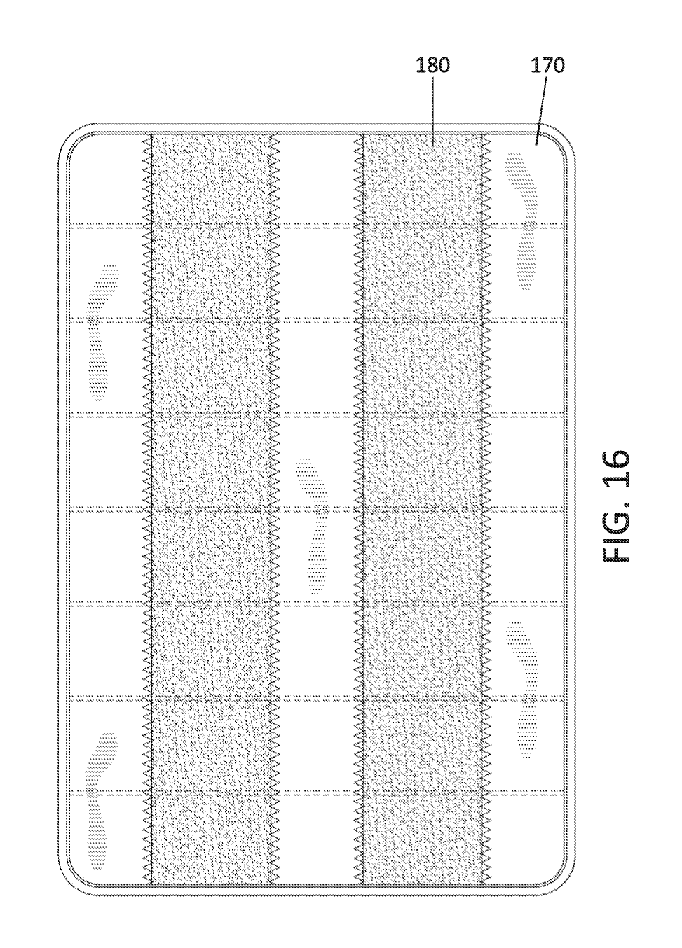

The non-skid portion 180 is a rubber or rubber-like material that is configured to resist slippage of the mat 100 on the floor and includes an inner perimeter (first edge) 182 and an outer perimeter (second edge) 184 and is placed on the surface of the bottom layer 160 facing the underlying floor, carpet, etc. (i.e., the underside of the mat 100). As shown in FIGS. 2 and 5, the non-skid portion 180 is disposed around the perimeter 162 of the bottom layer 160 such that the non-skid portion 180 surrounds the breathable fabric portion 170. It is to be understood, however, that the non-skid portion can be configured in various geometric patterns, such as but not limited to, a horizontal or vertical pattern (see FIGS. 6, 10, and 14-16), a diagonal pattern (see FIG. 7), a circular pattern (see FIG. 8), a block pattern (not shown), any other geometric pattern (not shown), or combinations thereof, as long as a certain percentage of the breathable fabric portion 170 is exposed to facilitate quick drying. Thus, the example embodiment described herein and illustrated in the figures is for illustration purposes only and is not intended to limit the scope of the invention.

The perimeter 172 of the breathable fabric portion 170 and the inner perimeter 182 of the non-skid material 180 are joined thereby forming a continuous surface of the third layer 180. In one embodiment, the breathable fabric portion 170 and the non-skid portion 180 may be pre-joined either with an adhesive or by sewing and then attached to a bottom surface of the intermediate layer 140 using an adhesive, such as but not limited to, a polyurethane-based adhesive, a water-based adhesive, etc. In another embodiment, the breathable fabric portion 170 and the non-skid portion 180 may each be attached to the intermediate layer 140 and then joined together as described herein.

As shown in the figures, once the breathable fabric portion 170 and the non-skid portion 180 are attached to the intermediate layer 140 the perimeters of each layer 120, 140, 160 are sewn together such that the edged perimeter 102 of the mat 100 is bonded.

The materials disclosed herein in the creation of the innovative mat have not been used in combination. More specifically, a breathable, quick drying material has not been used in combination with a non-skid material to form the bottom layer of a mat that has non-skid features and quick drying features. The innovative mat, however, has demonstrated both features. For example, during testing of the mat 100, the mat 100 exhibited the fast drying properties when dried in a dryer even with the inclusion of the non-skid portion 180 on the bottom layer 160 of the mat 100.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mat comprising:
a first layer including a fiber material;
a compressible second layer disposed below the first layer; and
a third layer disposed below the compressible second layer and including a breathable fiber portion and a non-skid material.

2. The mat according to claim 1, wherein the fiber material of the first layer is a microfiber material.

3. The mat according to claim 2, wherein the microfiber material is at least one material selected from the group of materials consisting of polyesters, polyamides and polypropylene.

4. The mat according to claim 3, wherein the polyamide is at least one material selected from the group consisting of nylon, aramids, para-aramids, and meta-aramids.

5. The mat according to claim 1, wherein the compressible second layer is a foam layer.

6. The mat according to claim 5, wherein the foam layer is polyurethane.

7. The mat according to claim 6, wherein the polyurethane is at least one selected from the group consisting of a viscoelastic polyurethane foam and a low-resilience polyurethane foam.

8. The mat of claim 1, wherein the breathable fiber portion includes an edged perimeter and the non-skid portion includes a first edge, and wherein the edged perimeter of the breathable fiber portion and the first edge of the non-skid portion are sewn together to form a continuous surface.

9. The mat of claim 1, wherein the breathable fiber portion includes an edged perimeter and the non-skid portion includes a first edge, and wherein an adhesive joins together the edged perimeter of the breathable fiber portion and the first edge of the non-skid portion to form a continuous surface.

10. The mat according to claim 1, wherein the breathable fiber portion of the third layer is a microfiber material.

11. The mat according to claim 10, wherein the microfiber material is at least one material selected from the group of materials consisting of polyesters, polyamides and polypropylene.

12. The mat according to claim 11, wherein the polyamide is at least one material selected from the group consisting of nylon, aramids, para-aramids, and meta-aramids.

13. The mat according to claim 1, wherein the non-skid material of the third layer is a material selected from the group consisting of rubber and a rubber-like material.

14. The mat according to claim 1, wherein a perimeter of the first layer and a perimeter of the third layer are joined to form a bond around an edged perimeter of the mat.

15. The mat according to claim 1, wherein the compressible second layer is secured to at least one of the first layer and the third layer.

16. The mat according to claim 1, wherein the compressible second layer is memory foam.

17. The mat according to claim 1, wherein the compressible second layer includes a plurality of foam layers having various densities and/or thicknesses.

18. The mat according to claim 1, wherein the surface of the third layer facing the floor comprises said non-skid material in a geometric pattern.

19. The mat according to claim 18, wherein the geometric pattern comprises a plurality of non-skid material sections in a configuration selected from the group consisting of diagonals, verticals, horizontals, circles, blocks, ovals, ovoids, squares, rectangles, triangles, and combinations thereof.

20. The mat according to claim 19, wherein the geometric pattern comprises a plurality of non-skid material sections in a rectangular configuration.
